(19) United States
(12) Patent Application Publication
(10) Pub. No.: US 2008/0246399 A1
(43) Pub. Date: Oct. 9, 2008

(54) Multi-layer electrode, method of forming the same and plasma display panel comprising the same

(76) Inventor: Chul-Hong Kim, Suwon-si (KR)

Correspondence Address: ROBERT E. BUSHNELL, 1522 K STREET NW, SUITE 300, WASHINGTON, DC, 20005-1202, US

(21) Appl. No.: 11/892,009

(22) Filed: Aug. 17, 2007

(30) Foreign Application Priority Data
Apr. 6, 2007 (KR) 10-2007-0034397

(51) Int. Cl. H01J 17/49; H01J 1/02; H01J 9/00

(52) U.S. Cl. 313/582; 313/326; 445/46

(57) ABSTRACT

A multi-layer electrode including a first metal layer including a first binder having a first acid value and a second metal layer arranged on the first metal layer, the second metal layer including a second binder having a second acid value that is smaller than the first acid value, a method of forming the multi-layer electrode and a plasma display panel (PDP) including the multi-layer electrode.

### CLAIM OF PRIORITY

This application makes reference to, incorporates the same herein, and claims all benefits accruing under 35 U.S.C.§119 from an application for MULTI-LAYER ELECTRODE, METHOD OF FORMING THE SAME AND PLASMA DISPLAY PANEL COMPRISING THE SAME earlier filed in the Korean Intellectual Property Office on 6 Apr. 2007 and there duly assigned Serial No. 10-2007-0034397.

### BACKGROUND OF THE INVENTION

1. Field of the Invention

The present invention relates to a multi-layer electrode, a method of forming the multi-layer electrode, and a plasma display panel employing the multi-layer electrode.

2. Description of the Related Art

A plasma display panel (PDP), which is spotlighted for replacing cathode ray tubes, is a device with two substrates sealed together, a plurality of electrodes formed on the substrates and a discharge gas injected between the two substrates. In the PDP, a discharge voltage is applied to the electrodes, and patterned phosphors excited by ultraviolet rays generated by the discharge voltage produce a visible image.

In general, a front substrate of the PDP includes optical transmitting electrodes and bus electrodes. The bus electrode complements electric conductivity of optical transmitting electrodes and is formed of a double-layer that includes a black layer and a white layer.

In order to form such a bus electrode structure, black paste is printed and plasticized, and white paste is printed, plasticized, and then patterned to form a bus electrode having the double-layer structure. The patterning process as described above uses a photo mask to conduct exposure and developing processes, thereby increasing the manufacturing costs and decreasing the manufacture yield.

In order to solve the problems associated with the patterning method, an offset printing method, which includes embossing for forming an electrode, has been developed. Japanese Patent Laid-Open Gazette No. 2004-18589 discloses a method of forming a bus electrode by forming a black layer using an offset printing method and forming a white layer on the black layer using an offset printing method. However, in the above Japanese Patent, transparent electrodes, black layers, and white layers are not ideally arranged and thus the distribution of characteristics such as black portion ratio and external reflection/brightness of the PDP are decreased, thereby significantly decreasing reliability of the PDP. What is therefore needed is a structure and a method of making the two or multi-layered bus electrodes that is simple and inexpensive to manufacture and produces high manufacturing yield.

### SUMMARY OF THE INVENTION

The present invention provides a multi-layer electrode in which good self-alignment of the layers is achieved.

The present invention also provides a method of forming a multi-layer electrode in which the layers are effectively arranged.

The present invention also provides a plasma display panel (PDP) having a multi-layered electrode in which the layers are effectively arranged and the multi-layered electrodes are easily formed having increased reliability and productibility.

According to an aspect of the present invention, there is provided a multi-layer PDP electrode that includes a first metal layer including a first binder having a first acid value and a second metal layer arranged on the first metal layer, the second metal layer including a second binder having a second acid value that is smaller than the first acid value. The first metal layer can have a higher etching selection ratio than the second metal layer with respect to an alkali developing solution that includes at least two elements selected from a group consisting of ammonia (NH₃), sodium carbonate (Na₂CO₃), potassium hydroxide (KOH), and tetramethylaluminium hydroxide (TMAH).

According to another aspect of the present invention, there is provided a method of forming a plasma display panel (PDP) electrode that includes forming a first metal layer including a first binder having a first acid value on a substrate, forming a second metal layer on the first metal layer formed on the substrate via an offset printing process, the second metal layer including a second binder having a second acid value that is smaller than the first acid value of the first metal layer; and etching the first metal layer with an alkali developing solution using the second metal layer as an etching mask. The method can also include plasticizing the first metal layer by UV curing. The alkali developing solution can include an element selected from a group consisting of ammonia (NH₃) and sodium carbonate (Na₂CO₃).

According to yet another aspect of the present invention, there is provided a plasma display panel (PDP) that includes a rear substrate, a front substrate arranged above the rear substrate and separated from the rear substrate, a plurality of barrier ribs arranged between the front and rear substrates and adapted to partition a plurality of discharge cells, a plurality of sustain electrode pairs that are arranged on the front substrate and include a first metal layer that includes a first binder having a first acid value and a second metal layer arranged on the first metal layer and including a second binder having a second acid value that is smaller than the first acid value, a plurality of address electrodes arranged on the rear substrate and a plurality of phosphor layers arranged within ones of the plurality of discharge cells. The first metal layer can have a smaller luminosity than the second metal layer. The second metal layer can have greater electric conductivity than the first metal layer. The first metal layer can include copper (Cu). The second metal layer can include silver (Ag).

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view illustrating a plasma display panel (PDP) electrode according to an embodiment of the present invention;

FIG. 2 is a cross-sectional view illustrating a PDP electrode according to another embodiment of the present invention;

FIGS. 3 through 6 are cross-sectional views illustrating a method of forming a PDP electrode according to an embodiment of the present invention; and

FIG. 7 is a partial cut-out perspective view illustrating a PDP according to an embodiment of the present invention.

### DETAILED DESCRIPTION OF THE INVENTION

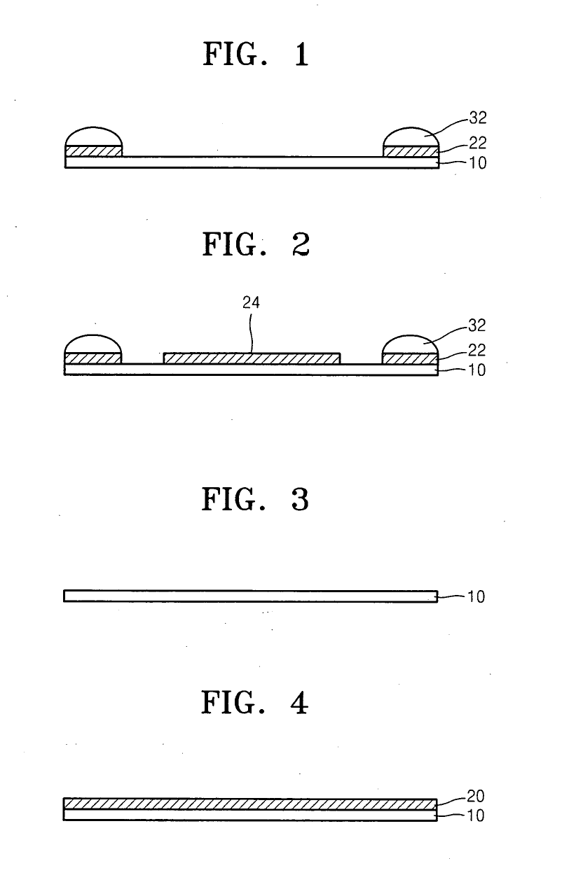

FIG. 1 is a cross-sectional view illustrating a plasma display panel (PDP) electrode according to an embodiment of the present invention. Referring to FIG. 1, a first metal layer 22 and a second metal layer 32 are formed on a predetermined region of a substrate 10. The current embodiment illustrates a double-layer electrode, however the present invention is not limited thereto, and can include an electrode formed of many more layers by designing organic binders between a top layer exposed in the upper portion and lower layers thereunder to have different acid values. According to the present invention, when the electrode is multi-layered, a top layer exposed in the upper portion can include a binder having an acid value that is lower than an acid value of the lower layers.

The first and second metal layers 22 and 32 include metal or metal oxide and a binder. The binder can be divided into an organic binder and an inorganic binder, and here, the first and second metal layers 22 and 32 include different organic binders, respectively. In detail, the first metal layer 22 includes a first binder having a first acid value, and the second metal layer 32 includes a second binder having a second acid value that is lower than the first acid value.

As the first and second metal layers 22 and 32 include organic binders each having different acid values, the first metal layer 22 has a higher etching selection ratio than the second metal layer 32 with respect to an alkali developing solution such as ammonia (NH₃), sodium carbonate (Na₂CO₃), potassium hydroxide (KOH), tetramethylaluminium hydroxide (TMAH), etc. Accordingly, in a method of forming an electrode to be described later, the first metal layer 22 can be etched using the second metal layer 32 as an etching mask.

The organic binder can be various types of polymers having an acid group, and among the various types, acryl resin is appropriate for cost economy. Monomers having a carboxyl group can be used as an acid group in the acrylic resin, and accordingly, the organic binder according to the present invention can be a copolymer formed of a monomer having a carboxyl group and at least one other monomer. The monomer having a carboxyl group can be one of acrylic acid, methacrylic acid, fumaric acid, maleic acid, vinyl acetate, and anhydrides thereof, but is not limited thereto. The other monomer copolymerized with the monomer having a carboxyl group can be one of methyl acrylate, methyl methacrylate, ethyl acrylate, ethyl methacrylate, n-butyl acrylate, n-butyl methacrylate, isobutyl acrylate, isobutyl methacrylate, 2-hydroxy ethyl acrylate, 2-hydroxy ethyl methacrylate, ethylene glycol monomethyl ether acrylate, ethylene glycol monomethyl ether methacrylate, styrene, and p-hydroxy styrene.

Also, the organic binder can be a material produced as a result of the reaction of the carboxyl group of the copolymer and an ethylene unsaturated compound, to which a component which causes a linking reaction to form the organic binder is added. The ethylene unsaturated compound can be one of glycidyl methacrylate, 4-epoxycyclohexyl methylmethacrylate, and 3,4-epoxycyclohexyl methylacrylate.

In addition, the organic binder can be a single copolymer or can be mixed with at least one of methylcellulose, ethylcellulose, nitrocellulose, hydroxymethylcellulose, hydroxyethylcellulose, hydroxypropylcellulose, carboxy methylcellulose, carboxy ethylcellulose, and carboxy ethylmethylcellulose for improving layer levelness or thixotropy. The molecular weight of the copolymer can be 5,000 to 100,000 g/mol, and the acid value can be 20 to 150 mgKOH/g. When the molecular weight of the copolymer is less than 5,000 g/mol, the printability of the paste is degraded, and when the molecular weight is greater than 100,000 g/mol, unexposed portions are not removed during a developing process.

The acid values of organic binders are analyzed, and an organic binder having a high acid value can be included in the first metal layer 22, and an organic binder having a low acid value can be included in the second metal layer 32. The acid value is the mass of potassium hydroxide (KOH) needed to neutralize an acidic compound. Thus the acid value is obtained by adding a solution including potassium hydroxide (KOH) to a compound, whose acid value is to be measured using an indicator, and determining the mass of the solution including potassium hydroxide (KOH) that was added to the acidic compound when the compound is neutralized, and then determining the mass of the potassium hydroxide (KOH) solution per 1 g of the compound based on the mass of the solution. The unit of the acid value is mg KOH/g.

The inorganic binder can increase the sintering characteristic of the metal or metal oxide and the adhesive force between the metal layers and the substrate in the plasticizing process. The inorganic binder can be Pb, Si, B, Al, Zn, Na, K, Mg, Ba, or a composite oxide of Bi. For example, the inorganic binder can be one of PbO—SiO₂, PbO—SiO₂—B₂O₃, PbO—SiO₂—B₂O₃—ZnO, PbO—SiO₂—B₂O₃—BaO, PbO—SiO₂—ZnO—BaO, ZnO—SiO₂, ZnO B₂O₃—SiO₂, ZnO—K₂O—B₂O₃—SiO₂—BaO, B₂O₃—SiO₂, B₂O₃—B₂O₃—SiO₂, B₂O₃—B₂O₃—SiO₂—BaO, and B₂O₃—B₂O₃—SiO₂—BaO—ZnO. Examples of the metal include copper (Cu), silver (Ag), gold (Au), platinum (Pt), aluminium (Al), nickel (Ni), tungsten (W), molybdenum (Mo), or an alloy thereof, such as silica, alumina, etc., and these metals are in powder form.

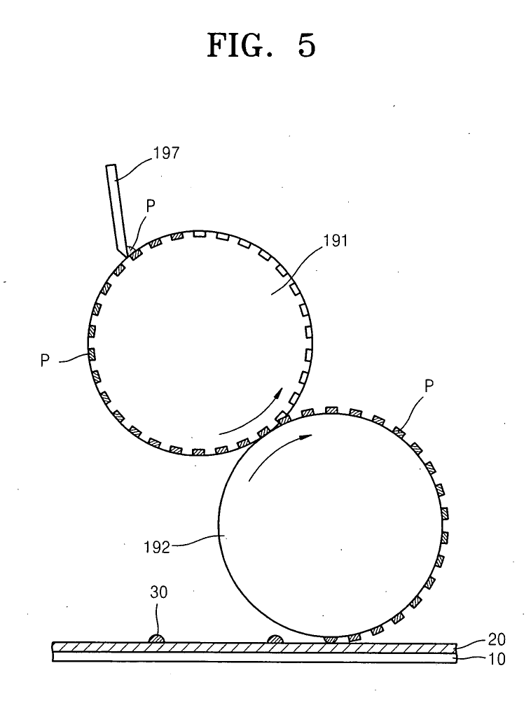

FIG. 2 is a cross-sectional view illustrating a PDP electrode according to another embodiment of the present invention. FIG. 2 includes a first metal layer 22 and a second metal layer 32 are formed on a predetermined region of a substrate 10 as in FIG. 1. Hereinafter, only differences of FIG. 2 from FIG. 1 will be described.

The first metal layer 22 is formed on the substrate 10, the second metal layer 32 is formed and aligned on the first metal layer 22, and a panel light absorption layer 24 is further formed on the substrate 10. The panel light absorption layer 24 increases the black portion ratio to reduce external light reflection, thereby improving image quality. The panel light absorption layer 24 can be formed of the same material as the first metal layer for simplifying the processes and can be formed in a stripe or in a matrix pattern. The panel light absorption layer 24 can be formed using an additional mask. Since the panel light absorption layer 24 is a single layer and there is a large alignment margin between the panel light absorption layer 24 and the first and second metal layers 22 and 32, misalignment between the panel light absorption layer 24 and the first and second metal layers 22 and 32 can be prevented despite the use of additional photographic processes.

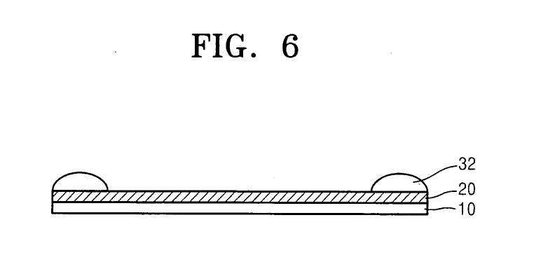

FIGS. 3 through 6 are cross-sectional views illustrating a method of forming a PDP electrode according to an embodiment of the present invention. Referring to FIG. 3, a substrate 10 is provided. The method of forming an electrode according to the present invention can be used for forming a bus electrode of a PDP. Thus, although the current embodiment illustrates a single substrate, a substrate including a transparent electrode can also be provided since a PDP includes a bus electrode formed on a transparent electrode.

Referring to FIG. 4, a first paste layer 20 is formed on the substrate 10. The first paste layer 20 includes metal or metal oxide, glass frit, a first binder, a photoinitiator, a linking agent, a solvent, and other additives. The first binder includes an organic binder having a first acid value. In detail, the first binder can include the organic binders described with reference to FIG. 1. The metal or metal oxide can be metals or oxides thereof described with reference to FIG. 1. The glass frit is thermal crystalline powder glass having a strong adhesive force, a strong mechanical intensity, and chemical durability. The glass frit can be one of B₂O₃—B₂O₃, B₂O₃—B₂O₃—ZnO, P₂O₅—SnO—ZnO, and B₂O₃—SnO—BaO.

Examples of the photo-initiator include benzophenone, o-benzoyl bezoic acid methyl, 4,4-bis(dimethylamine)benzophenon, 4,4-bis(diethylamino)benzophenone, 2,2-diethoxyacetophenone, 2,2-dimethoxy-2-phenyl-2-phenylacetophenone, 2-methyl-[4-(methylthio)phenyl]-2-morpolynopropan-1-on, 2-benzyl-2-dimethylamino-1-(4-morpolynophenyl)-1-buthanone, bis(2,6-dimethoxy benzoyl)-2,4,4-trimethyl phentyl phospine oxide, and bis(2,4,6-trimethylbenzoyl)phenyl phosphine oxide and mixtures thereof.

Examples of the solvent include ethyl carbitol, butyl carbitol, ethyl carbitol acetate, butyl carbitol acetate, texanol, terpine oil, dipropylene glycol methylether, dipropylene glycol ethylether, dipropylene glycol monomethylether acetate, γ-butyrolactone, cellosolve acetate, butyl cellosolve acetate, and tripropylene glycol, and mixtures thereof.

In addition, examples of the additives include a sensitizer for increasing sensitivity of an acid-base reaction, a polymerization inhibitor and an antioxidant for increasing maintainability of the composition, an ultraviolet ray absorbing agent for increasing the resolution of the PDP, a defoamer for reducing foam in the composition, a dispersing agent for increasing the dispersibility of the composition, a leveling agent for increasing the flatness of the layers during printing, and a plasticizer for increasing the printability of the composition. The additives are not requirements but can be used upon necessity.

After the first paste layer 20 is coated, the first paste layer 20 is dried using heat or light and plasticized.

Referring to FIG. 5, a second paste layer 30 is formed on first paste layer 20 that is formed on the substrate 10 using an offset printing method. In detail, a gravure roll 191 and a blanket roll 192, which rotates in the opposite direction to the gravure roll 191 and engages with the gravure roll 191, are set on the first paste layer 20 that is formed on the substrate 10. The gravure roll 191 includes grooves, and a second paste P is filled in the grooves. In addition, the second paste P overflowing from the grooves is removed using a blade 197.

The second paste P includes metal or metal oxide, glass frit, a second binder, a photo-initiator, a linking agent, a solvent, and other additives. The second paste P includes a second binder which is an organic binder having a second acid value that is smaller than the first acid value.

Then, the gravure roll 191 and the blanket roll 192 are rotated to transfer the second paste P filled in the grooves of the gravure roll 191. Also, the substrate 10 on which the first paste layer 20 is formed, is transported to print the second paste P transferred to the surface of the blanket roll 192 on portions of the first paste layer 20 which are selected in advance. Accordingly, the second paste layer 30 is formed on the first paste layer 20.

Referring to FIG. 6, the first paste layer 20 and the second paste layer 30 are plasticized on the substrate 10. Accordingly, the solvent in the second paste layer is removed from the second paste layer 30 to form the second metal layer 32. Plasticizing is performed by UV curing, and thus deformation due to heat can be prevented. Plasticizing according to the current embodiment of the present invention denotes hardening the second metal layer 32 such that the second metal layer 32 can be used as a mask in a subsequent etching process. Also, spheronization of the second metal layer 32 is reduced by plasticization according to the current embodiment, thereby suppressing an increase in electrode resistance.

The first paste layer 20 is etched using the second metal layer 32 as an etching mask. The developing solution used herein can be an alkali developing solution such as sodium carbonate (Na₂CO₃), potassium hydroxide (KOH), and tetramethylaluminium hydroxide (TMAH). The first paste layer 20 includes a first binder having a first acid value, and the second paste layer 30 includes a second binder having a second acid value that is smaller than the first acid value. Thus a portion of the first paste layer 20, which is not covered by the second paste layer 30 but exposed, can be etched using the alkali developing solution. Thus the first metal layer 22 is formed. As described above, an electrode is formed using a self-alignment method and a photo-process is not performed, thereby simplifying the process and preventing misalignment between the first metal layer 22 and the second metal layer 32.

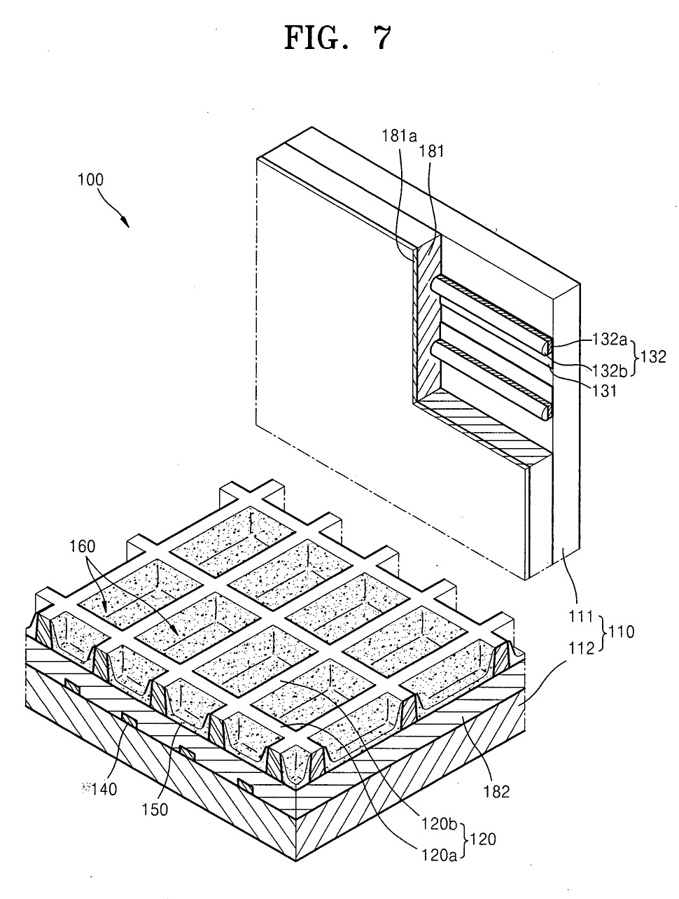

FIG. 7 is a partial cut-out perspective view illustrating a PDP 100 according to an embodiment of the present invention that uses the multi-layered bus electrode structure. The PDP 100 includes a pair of substrates 110, barrier ribs 120, sustain electrodes, address electrodes 140, and phosphor layers 150. The pair of substrates 110 includes a first substrate 111 and a second substrate 112. The first substrate 111 and the second substrate 112 are separated by a distance and face each other. The first substrate 111 is made out of transparent glass such that visible light can be transmitted therethrough.

In the current embodiment, since the first substrate 111 is transparent, visible light generated by the discharge is transmitted through the first substrate 111, but the present invention is not limited thereto. As an alternative, both the first substrate 111 and the second substrate 112 can be transparent. Also, the first substrate 111 and the second substrate 112 can be semi-transparent and can include a color filter mounted on the surface or inside thereof.

The barrier ribs 120 are arranged between the pair of substrates 110. The barrier ribs 120 maintain a discharge distance and partition discharge spaces with the sustain electrodes to form discharge cells 160, and prevent electric and optical cross-talk between the partitioned discharge cells 160. The barrier ribs 120 include horizontal barrier ribs 120a arranged parallel to the sustain electrodes and vertical barrier ribs 120b crossing the horizontal barrier ribs 120a at right angles.

In the current embodiment, a cross-section of the discharge cells 160 partitioned by the barrier ribs 120 is illustrated as a quadrangle, but the present invention is not limited thereto as the discharge cells can instead have other shapes, such as a triangle, a pentagon, a circle, or an oval. The barrier ribs 120 can instead be formed as stripes such that the barrier ribs 120 form open cell structures. The sustain electrodes are formed of light transmitting electrodes 131 and bus electrodes 132. The light transmitting electrodes 131 are formed in stripes on a lower surface of the first substrate 111 and include indium tin oxide (ITO), which transmits visible light and has a thickness of about 0.10-0.15 μm.

According to an embodiment of the present invention, the light transmitting electrodes 131 include ITO, but are not limited thereto. That is, the light transmitting electrodes only need to be formed of a material that has good electric conductivity and can transmit light, which can be a material other than ITO. According to an embodiment of the present invention, the light transmitting electrodes 131 are formed on the first substrate 111, but are not limited thereto. That is, the PDP according to the present invention does not necessarily have to include light transmitting electrodes. If light transmitting electrodes are not used, it is preferable to divide the bus electrodes into several strips to reduce the width thereof, thereby increasing the open ratio and enabling sustain discharge.

Meanwhile, the bus electrodes 132 are arranged to compensate for the electric conductivity of the light transmitting electrodes 131 and are formed of double layers. That is, each bus electrode 132 includes a first bus electrode layer 132a and a second bus electrode layer 132b. The first bus electrode layer 132a is formed on the light transmitting electrode 131 to a thickness of about 1.3-1.7 μm, and the second bus electrode layer 132b is formed on the first bus electrode layer 132a to a thickness of about 5-5.5 μm. The first bus electrode layer 132a includes a first binder having a first acid value, and the second bus electrode layer 132b includes a second binder having a second acid value that is smaller than the first acid value, and each can be formed using the first metal layer and the second metal layer illustrated in FIG. 1.

The color of the first bus electrode layer 132a has low luminosity so as to increase bright room contrast by increasing the black portion ratio. Accordingly, the first bus electrode layer 132a can be formed to have a black type color by including a conductive material such as copper (Cu). Here, a black type color does not only refer to black but to any color that can efficiently absorb visible light, and can be for example, dark gray, brown, etc. The second bus electrode layer 132b includes a metal having good electric conductivity; for example, the second bus electrode layer 132b can be made out of a conductive material such as silver (Ag).

A first dielectric layer 181 is formed on the first substrate 111 and buries the light transmitting electrodes 131, the bus electrodes 132, and a panel light absorption layer. The first dielectric layer 181 prevents direct conduction between the sustain electrodes during sustain discharge and prevents charged particles from directly colliding with the sustain electrodes and damaging the sustain electrodes. The first dielectric layer 181 can also accumulate wall charges by inducing charged particles. Examples of such dielectric materials include PbO, B₂O₃, SiO₂, etc.

A protection layer 181a is formed on a lower surface of the first dielectric layer 181. The protection layer 181a is preferably made out of magnesium oxide (MgO). The protection layer 181a prevents the sustain electrodes from being damaged by sputtering plasma particles and emits secondary electrons to reduce the discharge voltage.

Meanwhile, the address electrodes 140 are arranged as stripes on the second substrate 112. The address electrodes 140 perform address discharge with those electrodes functioning as scanning electrodes among the sustain electrodes arranged on the first substrate 111. A second dielectric layer 182 is formed on the second substrate 112 and buries the address electrodes 140. The second dielectric layer 182 protects the address electrodes 140.

Meanwhile, a top surface of the second dielectric layer 182 forms a lower surface of the discharge cells 160. This top surface of second dielectric layer 182 together with sides of the barrier ribs 120 are coated with phosphors layers 150 that emit blue, green, and red visible light upon being excited by ultraviolet rays. The phosphor layers 150 are divided into blue light emitting phosphor layers, green light emitting phosphor layers, and red light emitting phosphor layers according to the color of the emitted visible light, each arranged in rows. Each phosphor layer 150 receiving ultraviolet rays emits visible light, the blue light emitting phosphor layer including a phosphor such as BaMgAl₁₀O₁₇:Eu, the green light emitting phosphor layer including a phosphor such as Zn₂SiO₄:Mn, and the red light emitting phosphor layer including a phosphor such as Y(V,P)O₄:Eu.

After the first substrate 111 and the second substrate 112 are adhered and sealed together, the inner spaces of the assembled PDP 100 still contain air. The air in the PDP 100 is completely exhausted and replaced with an appropriate discharge gas that serves to increase the discharge efficiency. The discharge gas, in general, can be a mixture gas such as Ne—Xe, He—Xe, He—Ne—Xe, etc.

According to the present invention, a multi-layer electrode includes binders having different acid values and is formed by etching using a self-alignment method, and thus a multi-layer electrode having excellent alignment is provided. Also, when etching using the self-alignment method, a photographic process or developing process for forming an etching mask for forming electrodes is not required, and thus the method of forming electrodes can be simplified. In addition, as a PDP having a multi-layer electrode with excellent alignment is provided, the distribution of characteristics such as decrease of black portion ratio and external light reflection are improved, thereby increasing reliability. Furthermore as the electrode is formed using a simplified manufacturing process, the productibility of the PDP can be increased.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A plasma display panel (PDP) electrode, comprising:
a first metal layer including a first binder having a first acid value; and
a second metal layer arranged on the first metal layer, the second metal layer including a second binder having a second acid value that is smaller than the first acid value.

2. The PDP electrode of claim 1, wherein the first metal layer has a higher etching selection ratio than the second metal layer with respect to an alkali developing solution.

3. The PDP electrode of claim 1, wherein the first metal layer has a higher etching selection ratio than the second metal layer with respect to an alkali developing solution that comprises at least two elements selected from a group consisting of ammonia (NH₃), sodium carbonate (Na₂CO₃), potassium hydroxide (KOH), and tetramethylaluminium hydroxide (TMAH).

4. A method of forming a plasma display panel (PDP) electrode, the method comprising:
forming a first metal layer on a substrate, the first metal layer including a first binder having a first acid value;
forming a second metal layer on the first metal layer formed on the substrate via an offset printing process, the second metal layer including a second binder having a second acid value that is smaller than the first acid value; and
etching the first metal layer with an alkali developing solution using the second metal layer as an etching mask.

5. The method of claim 4, further comprising plasticizing the first metal layer by UV curing.

6. The method of claim 4, wherein the alkali developing solution comprises an element selected from a group consisting of ammonia (NH₃) and sodium carbonate (Na₂CO₃).

7. A plasma display panel (PDP), comprising:
a rear substrate;
a front substrate arranged above the rear substrate and separated from the rear substrate;
a plurality of barrier ribs arranged between the front and rear substrates and adapted to partition a plurality of discharge cells;
a plurality of sustain electrode pairs that are arranged on the front substrate, each of the plurality of sustain electrodes includes a first metal layer that includes a first binder having a first acid value and a second metal layer arranged on the first metal layer and including a second binder having a second acid value that is smaller than the first acid value;
a plurality of address electrodes arranged on the rear substrate; and
a plurality of phosphor layers arranged within ones of the plurality of discharge cells.

8. The PDP of claim 7, wherein the first metal layer has a smaller luminosity than the second metal layer.

9. The PDP of claim 7, wherein the second metal layer has greater electric conductivity than the first metal layer.

10. The PDP of claim 7, wherein the first metal layer comprises copper (Cu).

11. The PDP of claim 7, wherein the second metal layer comprises silver (Ag).
